(19) United States
(12) Patent Application Publication
(10) Pub. No.: US 2025/0050827 A1
(43) Pub. Date: Feb. 13, 2025

(54) CONNECTION DEVICE FOR A CONTROL UNIT FOR A VEHICLE

(71) Applicant: ZF ACTIVE SAFETY AND ELECTRONICS US LLC., Livonia, MI (US)

(72) Inventors: Maciej KUDANOWSKI, West Midlands (GB); Kevin COCKERHAM, West Midlands (GB)

(21) Appl. No.: 18/718,948

(22) PCT Filed: Dec. 12, 2021
(86) PCT No.: PCT/US2021/062992

§ 371 Date: Jun. 13, 2024

(51) Int. Cl. B60R 16/023; B60R 16/033

(52) U.S. Cl. CPC B60R 16/0231; B60R 16/033

(57) ABSTRACT

Connection device (3) for a control unit (4) for a vehicle, the connection device (3) comprising at least one power input interface (9-11) for connecting the connection device (3) to a power source (2) and at least one power output interface (12-15) for connecting the connection device (3) to the control unit (4), wherein the connection device (3) comprises three power input interfaces (9-11) and four power output inter-faces (12-15) for connecting a power source (2) with three power output connections to a control unit (4) comprising four power input connections.

### TECHNICAL FIELD

The invention relates to a connection device for a control unit for a vehicle, the connection device comprising at least one power input interface for connecting the connection device to a power source and at least one power output interface for connecting the connection device to a control unit.

### BACKGROUND

Connection devices for control units for vehicles are generally known from prior art. Usually, a connection device is used to connect the power source to the control unit in order to establish a power supply for the control unit, e.g. for connecting a vehicle battery to a control unit, particularly controlling different functional units/elements of the vehicle, such as an electronic power steering, a generator control or other consumers. It is further known from prior art that control units have to fulfill certain requirements, e.g. safety requirements, such as different safety ratings, e.g. ASIL ratings. Modern control units therefore require a defined set of input connections, e.g. four input connections while vehicles exist that only provide power sources with at least three power outputs. In the power supply of a commercial vehicle, e.g. a truck, power supplies can be used that provide a voltage of 24V in a regular mode of operation, e.g. provided by two power source units each providing a voltage of 12V.

Thus, such a “traditional” power source can usually only provide three power output connections, while control units exist that rely on four input connections. Therefore, connecting a standard power source of a commercial vehicle, e.g. providing a single 24V supply, to a “multilane” control unit, such as a control unit for an electrical power steering, could negate some of the redundant ECU features.

### SUMMARY

It is an object of the present invention to provide an improved connection device for a control unit of a vehicle, particularly a commercial vehicle.

The object is inventively achieved by a connection device according to claim 1. Advantageous embodiments are subject to the dependent claims.

As described before, the invention relates to a connection device for a control unit for a vehicle. The connection device is used to connect a control unit to a power source, particularly a control unit of a commercial vehicle, e.g. a truck. The connection device is particularly adapted to establish a connection between a power source that provides exactly three power output connections and a control unit that requires four power input connections. For establishing the connection between the power source and the control unit, the connection device comprises three power input interfaces and four power output interfaces. In other words, the control unit can be connected to the four power output interfaces of the connection device while the power source can be connected to the three power input interfaces of the connection device.

The connection device can comprise exactly three power input interfaces and exactly four power output interfaces to supply power to a control unit that requires four inputs from a power source that provides only three outputs. In other words, the inventive connection device allows for connecting a three-wire power source to a four-wire safety controller or control unit. In a traditional battery configuration that comprises two power source units, e.g. two 12V battery units, the inventive connection device allows for connecting a power source to a control unit that fulfills a certain safety rating, e.g. an ASIL-D type control unit (although overall Item integrity may be limited). Hence, the connection device can be used to provide power to a modern control unit while a traditional power source can be used.

The four power output interfaces can be divided into two pairs of power output interfaces for connecting two control elements of the control unit to the power source. In other words, the four power output interfaces can be grouped into two pairs, while a first pair of power output interface comprising two power output interfaces are used to supply power to a first control element while a second pair of power output interfaces also comprising two power output interfaces is used to supply power to a second control element. The control elements can be any type of functional unit or functional element of the vehicle, such as control unit or part of control units, an electrical power steering and the like. The control elements can be regarded as “lanes” of the control unit that can operate on their own or the control unit can operate other units connected with or to the control elements. Particularly, the control elements can control functions on their own based on a safety rating, e.g. an ASIL rating.

The connection device can comprise a first power input interface for connecting a first terminal of a first power source unit, in particular a first 12V battery unit, and a second power input interface for connecting a second terminal of a second power source unit, in particular a second 12V battery unit, and a third power input interface for connecting a second terminal of the first power source unit and a first terminal of the second power source unit with the control unit. The connection device therefore comprises a first power input interface, a second power input interface and a third power input interface for establishing the connection with the three power outputs of the power source. In regular mode of operation power can be supplied to the control unit via the first power input interface and the second power input interface.

In a failure mode, the third power input interface is used. For example, if the first or second power source unit is defective, power can still be supplied to the control unit via either the first power input interface and the third power input interface or the third power input interface and the second power input interface. In a regular mode of operation each of the elements of the control unit can be powered by both power source units together, while in the fault operation each control element can be powered by a single power source unit only.

In a further embodiment, the connection device is adapted to connect the first terminal of the first power source unit to a first port of the first control element and a first port of a second control element and the connection device is further adapted to connect the second terminal of the second power source unit to a first port of the first control element and a second port of the second control element and the connection device is adapted to connect the second terminal of the first power source unit to the second port of the first control element and the second port of the second control element and the first terminal of the second power source unit to the first port of the first control element and the first port of the second control element.

The connection device thereby defines passages or paths for flowing current from the power source to the control elements of the control unit. As described above, the connection between the first terminal and the second terminal of the power source, particularly the first terminal of the first power source and the second terminal of the second power source that are arranged in a series configuration, are used in a regular mode of operation. If a failure occurs, particularly taking the first power source unit or the second power source unit out of operation, the third power input interface is used to connect the remaining power source unit to the control elements.

Thus, in a fault operation the first port of the first control element and the first port of the second control element are either connected to the first terminal of the first power source unit or the first terminal of the second power source unit, depending on which power source unit is still operational. Accordingly, the second port of the first control element and the second port of the second control element are either connected to the second terminal of the first power source unit or the second terminal of the second power source unit, depending on which power source unit is still operational. Hence, if two power source units are used each providing a voltage of 12V, in the failure mode a (limited) operation of the control elements with a single power source is still possible.

In another advantageous embodiment of the connection device, the connection device may comprise at least two modules. A first module can be adapted to connect the three power output connections of a power source to two power input connections of a first control element of a control unit and a second module can be adapted to connect the three power output connections of a power source to two power input connections of a second control element of a control unit. In other words, the connection device may comprise a first module and a second module, wherein each module can be assigned to a specific control element. The first module can be used to establish the connection between the three power output connections of the power source, as described before, to the first control element, wherein the second control element is supplied via the second module. Each of the modules may comprise a first, second and third power input interface that can be connected to the corresponding power outputs of the power source units, as described before. Each of the modules only has two power output interfaces for connecting the power source to the power inputs of the assigned control element, as described before.

Providing the connection device with at least two modules improves power dissipation over the modules. Particularly the power dissipation can be split over the modules. Further, a separation of the modules in different paths further improves the likelihood of failures. Particularly, an improvement against dependent failures is realized. In other words, the four power output interfaces provided by the connection device are distributed over the at least two modules.

The connection device may further comprise at least one current control unit in each power input interface and/or power output interface, wherein the current control unit is adapted to control the flow of electrical current from the power source to the control unit through the current control unit. In other words, the current control unit can be used to control in which direction a flow of electrical current is possible. Inter alia, the connection device comprises a plurality of current control units that are arranged in or assigned to the different paths between the power input interfaces and the power output interfaces.

For example, in the first power input interface connecting the first terminal, e.g. a positive terminal, of the power source with the first ports of the first element and the second element, a first current control unit can be provided that permits flow of current from the first terminal, e.g. a positive terminal, to the first port of the elements, while a flow of current in the opposite direction is blocked. Likewise, in the second power input interface connecting the second terminal, e.g. a negative terminal, of the power source with the second ports of the first element and the second element, a second current control unit can be provided permitting flow of current from the second ports of the elements to the second terminal, wherein a flow of current in the opposite direction is blocked.

Regarding the third power input interface, at least one third current control unit can be provided in the connection leading to the first ports of the first and second element, while at least one fourth current control unit can be provided in the connection leading to the second ports of the first and second element. Particularly, the third current control unit can allow a flow of current from a first terminal, e.g. a positive terminal, of the second power source unit to the first ports of the first and second control element, while a flow of current in the opposite directions blocked. The fourth current control unit can allow for a flow of current from the second ports of the first and second control elements to the second terminal, e.g. a negative terminal, of the first power source unit while a flow of current in the opposite direction is blocked. In general, the terms “first” and “second” and the terms “positive” and “negative” are merely exemplary and can be changed arbitrarily.

As describe before, the connection device may comprise current control units for controlling the flow of current through the connection device. The current control units can be built as or comprise diodes and/or switches and/or MOSFETs. Basically, it is possible to use passive electrical elements as current control units, such as diodes, in that an active control of the current control unit, i.e. requiring active control means, is not necessary. Other types of current control units provide other advantages, such as a lower voltage drop or lower power dissipation and the possibility to actively control current control units, e.g. for different operating conditions. A redundant arrangement of two current control units in the same path is further possible. An arbitrary combination of two like current control units or different current control units is also possible. Hence, in case of a failure of one current control unit, the other current control unit can still control the flow of current through the corresponding path in the connection device.

As describe before, a passive control of the flow of electrical current through the current control unit is possible. The connection device can further be adapted to actively control the at least one current control unit. For example, in case of an actively controlled switch and/or a MOSFET, it is possible to actively control the current that flows through the current control unit. Thus, adjusting different currents for different operating conditions can be performed. It is particularly possible to change the direction or magnitude of the current that flows through each path that is provided with a current control unit.

Besides, the invention relates to a control circuit comprising a control unit with four power input connections, a power source with three power output connections and a connection device as described before. The connection device can be used to establish the connection between the power source and the control unit, as describe before. Further, the invention relates to a vehicle, particularly a commercial vehicle, such as a truck, that comprises a connecting device, as described before, or a control circuit, as describe before.

### BRIEF DESCRIPTION OF THE DRAWINGS

All details, features and advantages that are described with respect to the connection device are fully transferable to the control circuit and the vehicle.

Advantageous embodiments of the invention are described in detail with respect to the Fig. The Fig. are schematic drawings showing:

FIG. 1 a control circuit comprising a power source and a connection device for a vehicle according to a first embodiment;

FIG. 2 a control circuit comprising a power source in the connection device for a vehicle according to a second embodiment;

FIG. 3 a control circuit comprising a power source in the connection device for a vehicle according to a third embodiment; and

FIG. 4 a control circuit comprising a power source in the connection device for a vehicle according to a fourth embodiment.

### DESCRIPTION

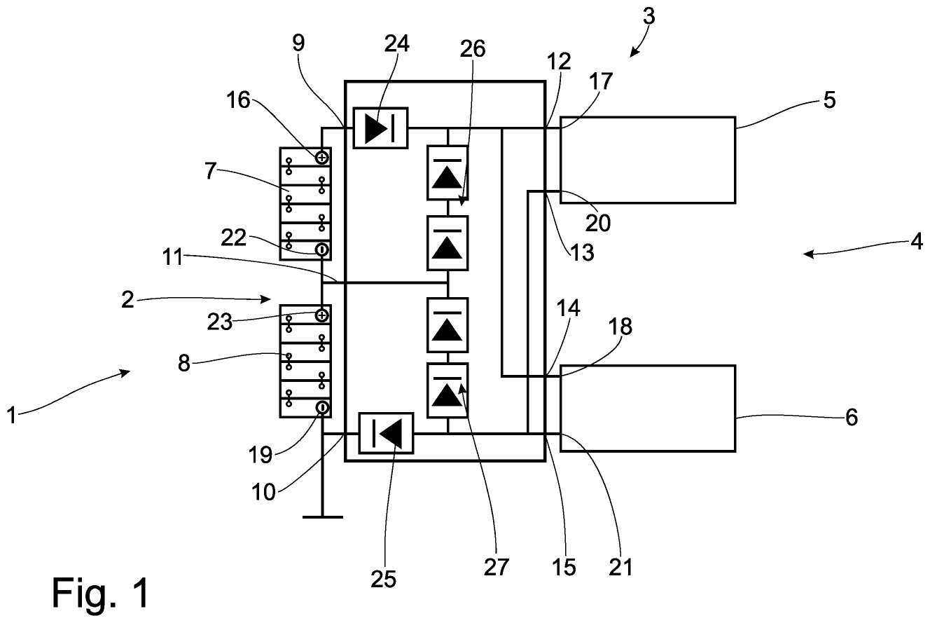

FIG. 1 shows a control circuit 1 comprising a power source 2 and a connection device 3 for connecting the power source 2 to a control unit 4, exemplary comprising a first control element 5 and a second control element 6. The power source 2 exemplarily provides a voltage of 24V by providing a first power source unit 7 and a second power source unit 8, each providing a voltage of 12V.

The connection device 3 comprises a first power input interface 9, a second power input interface 10 and a third power input interface 11. Further, the connection device 3 comprises a first power output interface 12, a second power output interface 13, a third power output interface 14 and a fourth power output interface 15. In other words, it is possible to connect to the power source 2 via the connection device 3 with the control unit 4, wherein the power source to comprises three power outputs and the control unit 4 comprises four power inputs.

Particularly, the first terminal 16 of the first power source unit 7 is connected to the first power input interface 9 of the connection device 3 connecting the first terminal 16 of the power source unit 7 to a first port 17 of the first control element 5 and the first port 18 of the second control element 6. A second terminal 19 of the second power source unit 8 is connected to the second power input interface 10 of the connection device 3 connecting the second terminal 19 to the second port 20 of the first control element 5 and the second port 21 of the second control element 6. In a regular mode of operation the power source 2 provides electrical current via the first power input interface 9 and the second power input interface 11 to the control elements 5, 6, as described before.

In a failure mode, e.g. if one of the power source units 7, 8 is defective, power is supplied via the third power input interface 11. The third power input interface 11 can connect a second terminal 22 of the first power source unit 7 to the first ports 17, 18 of the control elements 5, 6, e.g. if the second power source unit 8 is defective. In case the first power source unit 7 is defective, the second ports 20, 21 of the control elements 5, 6 can be connected via the third power input interface 11 to the first terminal 23 of the second power source unit 8.

For controlling the flow of current through the connection device 3, the connection device 3 comprises current control units. Generally, each unit can be used as current control unit that is adapted to control the current through the respective passage, e.g. from the power input interfaces 9-11 to the power output interfaces 12-15. In the embodiment that is depicted in FIG. 1, diodes are used as current control units. For example, a first current control unit 24 is arranged in the first power input interface 9 in that a flow of current is permitted between the first terminal 16 and the first ports 17, 18 of the control elements 5, 6, whereas a flow of current in the opposite direction is blocked. The connection device 3 further comprises a second current control unit 25 that is arranged in the second power input interface 10 in that a flow of current is permitted between the second ports 20, 21 of the control elements 5, 6 and the second terminal 19, whereas a flow of current in the opposite direction is blocked.

Further, the connection device 3 comprises a third current control unit 26 and a fourth current control unit 27 arranged in the third power input interface 11. Although the third current control unit 26 and the fourth current control unit 27 each comprise two diodes, the use of a single diode or any other combination of current control units is possible. The third current control unit 26 permits a flow of current between the first terminal 23 of the second power source unit 8 and the first ports 17, 18 of the control elements 5, 6 and blocks a flow of current in the opposite direction. The fourth current control unit 27 permits a flow of current between the second ports 20, 21 of the control elements 5, 6 and the second terminal 22 of the first power source unit 7 and blocks a flow of current in the opposite direction. Thus, it is possible to supply power to the control elements 5, 6 in case one of the power source units 7, 8 is out of operation.

The description of the basic working principle of the connection device 3 is transferable to all other embodiments of connection devices 3 hereinafter. The same reference signs are used for the same elements of the control circuit 1 or the connection device 3. In general, the terms “first” and “second”, the current flow direction and the terms “positive” and “negative” can be arbitrarily changed.

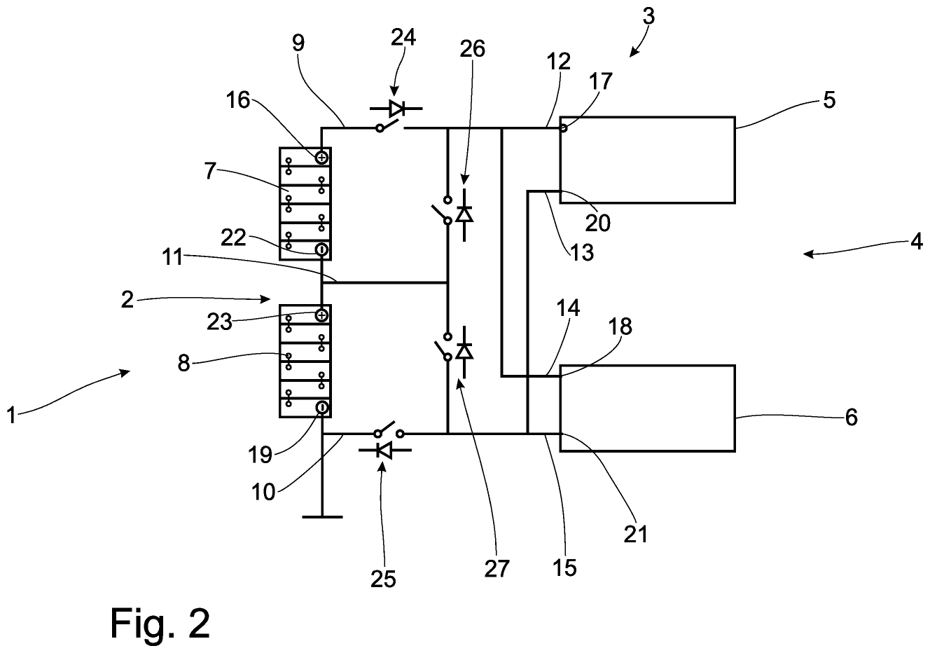

FIG. 2 shows a control circuit 1 with a power source 2 and a connection device 3, as describe before. In the second embodiment according to FIG. 2, the current control units 24-27 can be actively controlled, e.g. as actively controlled switches. Each of the current control units 24-27 can be opened or closed based on a control signal of a control unit that is not further depicted.

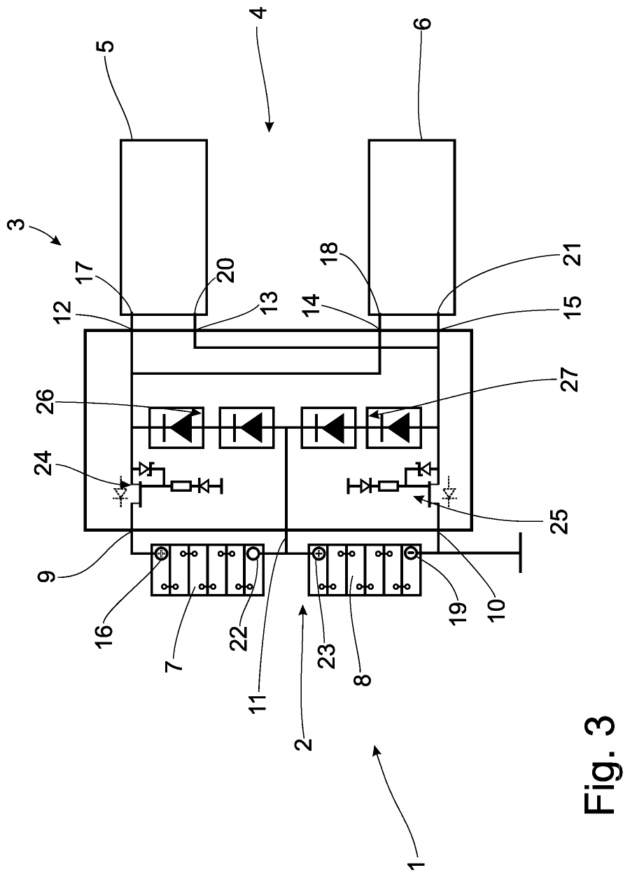

FIG. 3 shows a control unit 1 comprising a power source 2 and the connection device 3, as describe before. Based on the first embodiment that is described with respect to FIG. 1, the embodiment depicted in FIG. 3 comprises a first current control unit 24 and a second current control unit 25 that are built as MOSFETs. The specific arrangement in which a PMOS is used as first current control unit 24 and an NMOS is used as second current control unit 25 is merely exemplary and can be changed arbitrarily.

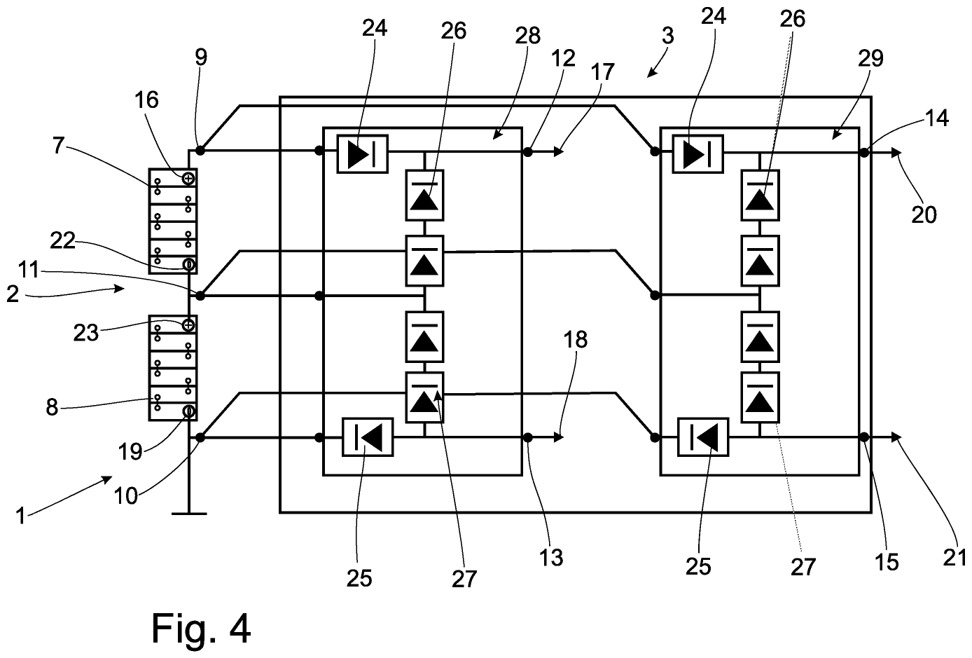

FIG. 4 shows a control circuit 1 according to a fourth embodiment, also comprising a power source 2 and a connection device 3. In the embodiment depicted in FIG. 4, the connection device 3 comprises two modules 28, 29 each comprising three power input interfaces 9-11, as describe before. In the embodiment depicted in FIG. 4, each of the modules 28, 29 comprises two power output interfaces 12-15. In this case, the first module 28 comprises a pair of output interfaces, namely the power output interfaces 12, 13 and the second module 29 also comprises a pair of output interfaces, namely the output interfaces 14, 15.

The modules 28, 29 can be used to provide power to control elements 5, 6, as describe before, wherein the first module 28 is assigned to a first control element 5 and the second module 29 is assigned to a second control element 6. In the embodiment of FIG. 4, the power dissipation is split over the first and second module 28, 29. Further, dependent failures can be reduced due to the separation of the function of the connection device 3 into the two modules 28, 29. The description of the operation of each of the modules 28, 29 can be arbitrarily transferred from above.

All features, details and advantages described with respect to the individual embodiments can be arbitrarily combined, transferred and exchanged. Particularly, it is possible to use any of the different current control units 24-27 in each of the embodiments and divide all connection devices 3 in the embodiments according to FIGS. 1-3 into the modular configuration according to FIG. 4, e.g. in individual modules 28, 29.

### REFERENCE SIGNS

1 control circuit
2 power source
3 connection device
4 control unit
5, 6 control element
7, 8 power source unit
9-11 power input interface
12-15 power output interface
16 first terminal
17, 18 first port
19 second terminal
20, 21 second port
22 second terminal
23 first terminal
24-27 current control unit
28, 29 module

1. Connection device (3) for a control unit (4) for a vehicle, the connection device (3) comprising at least one power input interface (9-11) for connecting the connection device (3) to a power source (2) and at least one power output interface (12-15) for connecting the connection device (3) to the control unit (4), characterized in that the connection device (3) comprises three power input interfaces (9-11) and four power output interfaces (12-15) for connecting a power source (2) with three power output connections to a control unit (4) comprising four power input connections.

2. Connection device (3) according to claim 1, wherein the four power output interfaces (12-15) are divided into two pairs of power output interfaces (12-15) for connecting two control elements (5, 6) of the control unit (4) to the power source (2).

3. Connection device (3) according to claim 1, wherein the connection device (3) comprises a first power input interface (9) for connecting a first terminal (16) of a first power source unit (7), in particular a first 12 V battery unit, and a second power input interface (10) for connecting a second terminal (19) of a second power source unit (8), in particular a second 12 V battery unit, and a third power input interface (11) for connecting a second terminal (22) of the first power source unit (7) and a first terminal (23) of the second power source unit (8) with the control unit (4).

4. Connection device (3) according to claim 3, wherein the connection device (3) is adapted to connect the first terminal (16) of the first power source unit (7) to a first port (17) of a first control element (5) and a first port (18) of a second control element (6) and adapted to connect the second terminal (19) of the second power source unit (8) to a second port (20) of the first control element (5) and a second port (21) of the second control element (6) and adapted to connect the second terminal (22) of the first power source unit (7) to the second port 20) of the first control element (5) and the second port (21) of the second control element (6) and the first terminal (23) of the second power source unit (8) to the first port (17) of the first control element (5) and the first port (18) of the second control element (6).

5. Connection device (3) according to claim 1, wherein the connection device (3) comprises at least two modules (28, 29), wherein a first module (28) is adapted to connect the three power output connections of a power source (2) to two power input connections of a first control element (5) of a control unit (4) and wherein a second module (29) is adapted to connect the three power output connections of a power source (2) to two power input connections of a second control element (6) of a control unit (4).

6. Connection device (3) according to claim 1, wherein the connection device (3) comprises at least one current control unit (24-27) in each power input interface (9-11) and/or power output interface (12-15) adapted to control the flow of electrical current from the power source (2) to the control unit through the current control unit (24-27).

7. Connection device (3) according to claim 6, wherein the current control unit (24-27) is or comprises a diode and/or a switch and/or a mosfet.

8. Connection device (3) according to claim 6, wherein the connection device (3) is adapted to actively control the at least one current control unit (24-27).

9. Control circuit (1) comprising a control unit (4) with four power input connections, a power source (2) with three power output connections and a connection device (3) according to claim 1 for connecting the power source (2) with the control unit (4).

10. Vehicle, in particular commercial vehicle, comprising a connection device (3) according to claim 1 or a control circuit (1) according to the preceding claim.
